(19) United States
(12) Patent Application Publication
(10) Pub. No.: US 2026/0302339 A1
(43) Pub. Date: Oct. 1, 2026

(54) BORATE-BASED SOLID ELECTROLYTE AND MANUFACTURING METHOD THEREOF

(71) Applicant: SUKGYUNG AT CO., LTD., Ansan-si, Gyeonggi-do (KR)

(72) Inventors: Hyung Sup LIM, Ansan-si, Gyeonggi-do (KR); Young Chul YOU, Ansan-si, Gyeonggi-do (KR); Sung Hwa LEE, Siheung-si, Gyeonggi-do (KR); Jin Hee LEE, Hwaseong-si, Gyeonggi-do (KR)

(73) Assignee: SUKGYUNG AT CO., LTD., Ansan-si, Gyeonggi-do (KR)

(21) Appl. No.: 19/478,191

(22) PCT Filed: Apr. 23, 2024
(86) PCT No.: PCT/KR2024/095761

§ 371 Date: Oct. 23, 2025

(30) Foreign Application Priority Data
Apr. 25, 2023 (KR) 10-2023-0054180
Apr. 22, 2024 (KR) 10-2024-0053482

(51) Int. Cl. H01M 10/0562; H01M 10/052

(52) U.S. Cl. CPC H01M 10/0562; H01M 10/052; H01M 2300/0068

(57) ABSTRACT

Provided is, as a lithium chloroboracite-based solid electrolyte having a composition of Li₄₊ₓB₇O_{12+x/2}Cl (x=0-1) prepared from LiOH or Li₂CO₃ and H₃BO₃ or B₂O₃ and LiCl raw materials, an all solid state electrolyte for an all solid state secondary battery having improved safety and ionic conductivity. Also provided is a method for preparing a solid electrolyte of lithium chloroboracite having a composition of Li₄₊ₓB₇O_{12+x/2}Cl (x=0-1).

### TECHNICAL FIELD

The present invention disclosed herein relates to an all solid state electrolyte for an all solid state secondary battery having improved safety and ionic conductivity.

### BACKGROUND ART

Secondary batteries are batteries made up of one or more electrochemical cells that are chargeable and dischargeable. Currently, lithium-ion batteries are at the forefront, serving as an essential for small electronic devices such as smartphones. The lithium-ion batteries are superior to traditional lead-acid batteries in avoiding environmental hazards and memory effect (a phenomenon in which repeated charging of batteries during use causes discharge voltage to drop and discharge capacity to decrease below nominal capacity), and also exhibit superior energy density per unit of mass and volume.

The secondary batteries typically have a higher initial cost than disposable batteries, but are rechargeable multiple times before being replaced, thereby offering the benefit of a significantly lower total cost and environmental impact. Some types of secondary batteries are available in the same size and voltage as disposable types and are interchangeable.

However, an electrolyte (liquid or gel) inside the lithium-ion batteries poses a risk of ignition and explosion due to thermal propagation. A number of actual explosion incidents have induced growing concerns over safety.

Therefore, replacing liquid electrolytes with solid electrolytes to overcome these shortcomings offers the following benefits.
The risk of fire and explosion from temperature changes and external impacts is significantly reduced, and safety devices and separators for temperature changes and external impacts are not required, allowing for cost reduction and high capacity with the same size.
Since there is no risk of fire, a space, where a cooling device that occupies over 30% of a battery pack space is removed, is provided with additional battery cells, thereby increasing energy density.
Since there is no need for a separator that physically blocks a positive electrode and a negative electrode in the liquid electrolyte to prevent electrical short circuits, volume reduction and cost reduction are achievable.
Lithium metal, which has superior performance (including a capacity up to 10 times that of graphite), but was not used due to the risk of fire and explosion between electrodes, may be used as a negative electrode active material, enabling high capacity to be achieved with the same size.

Meanwhile, as such a solid electrolyte, a sulfide-based solid electrolyte using a Li₂S—P₂S₅—LiCl ternary raw material having an argyrodite crystal structure has been developed. However, the typical sulfide-based solid electrolyte is hazardous due to the potential generation of harmful compounds such as hydrogen sulfide (H₂S). That is, in practice, there remain numerous controversies and challenges, including solid electrolyte materials, high resistance at an active material-electrolyte interface (interfacial resistance), and manufacturing processes. Therefore, the need has emerged to develop a safe and mass-producible solid electrolyte capable of fundamentally eliminating the risks posed by the typical sulfide-based solid electrolyte.

### DISCLOSURE OF THE INVENTION

### Technical Problem

The present invention provides preparing a borate-based solid electrolyte material in the form of particles, with high purity and ionic conductivity, and applying the borate-based solid electrolyte to a lithium ion conductor for an all solid state battery.

The present invention also provides a borate-based solid electrolyte material to the industry, thereby enabling economic advantages and ensuring superior safety in handling raw materials.

### Technical Solution

After years of research to prepare a solid electrolyte that meets the needs of the industry, the researchers synthesized a lithium chloroboracite-based solid electrolyte. In accordance with an embodiment of the present invention, a solid electrolyte is lithium chloroboracite having a composition of Li₄₊ₓB₇O_{12+x/2}Cl (x=0-1).

The lithium chloroborasite may be prepared from LiOH or Li₂CO₃ and H₃BO₃ or B₂O₃ and LiCl raw materials, and the solid electrolyte may have a Li ionic conductivity of 1.0×10⁻⁶ S/cm or greater at room temperature (25° C.).

In addition, the lithium chloroborasite may be a nanoparticle having a diameter of 10 nm to 300 μm. Preferably, the particle size is 0.8 to 80 μm in diameter, and more preferably 1 to 20 μm. A smaller particle size may increase density and thus is preferable for ionic conductivity, but presents processing difficulties. Conversely, too large particles cause a decrease in density and homogeneity of a solid electrolyte membrane.

In accordance with another embodiment of the present invention, the solid electrolyte of lithium chloroboracite having a composition of Li₄₊ₓB₇O_{12+x/2}Cl (x=0-1) is prepared by including steps of mixing LiOH or Li₂CO₃ and H₃BO₃ or B₂O₃ and LiCl raw materials, melting and quenching the raw material mixture at 600° C. or greater, and recovering and pulverizing the melt after cooling.

The lithium chloroboracite-based solid electrolyte according to the present invention may resolve the issue of environmental stability in which P₂S₅ and Li₂S, which are used as raw materials for typical argyrodite-based sulfide solid electrolytes, react with moisture to generate hydrogen sulfide (H₂S), and accordingly, a secondary battery manufactured to include the lithium chloroboracite-based solid electrolyte may replace a secondary battery using typical liquid electrolytes in the market.

### Advantageous Effects

The present invention provides a solid electrolyte in the form of particles, with high purity and ionic conductivity by synthesizing a lithium chloroboracite-based solid electrolyte.

In addition, the lithium chloroboracite-based solid electrolyte according to the present invention may resolve the issue of environmental stability in which P₂S₅ and Li₂S, which are used as raw materials for typical argyrodite-based sulfide solid electrolytes, react with moisture to generate hydrogen sulfide (H₂S).

In addition, a secondary battery manufactured to include the lithium chloroboracite-based solid electrolyte may replace a secondary battery using typical liquid electrolytes in the market.

### BRIEF DESCRIPTION OF THE DRAWINGS

FIG. 1 shows XRD data of lithium chloroborasite;

FIG. 2 is an SEM image showing lithium chloroborasite particle sizes of 2 to 40 m;

FIG. 3 shows an image of lithium chloroborasite after gold coating;

FIG. 4 is an SEM-BSE (Back Scattered Electron) image determining a coating thickness of lithium chloroborasite after gold coating in FIG. 3;

FIG. 5 shows data measuring Li ionic conductivity at room temperature after gold coating; and

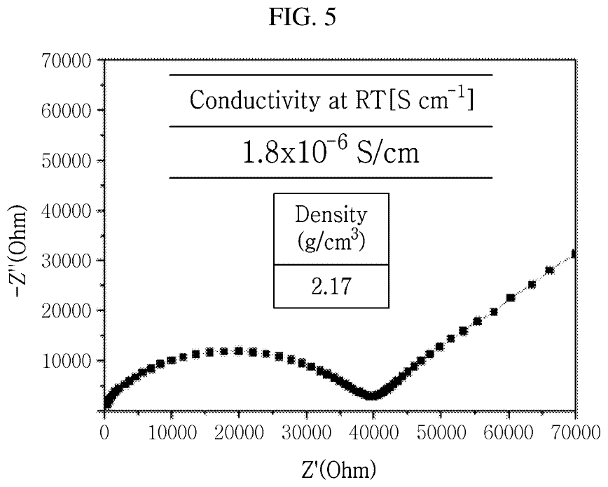

FIG. 6 is a graph showing changes in ionic conductivity with temperature for a solid electrolyte according to the present invention.

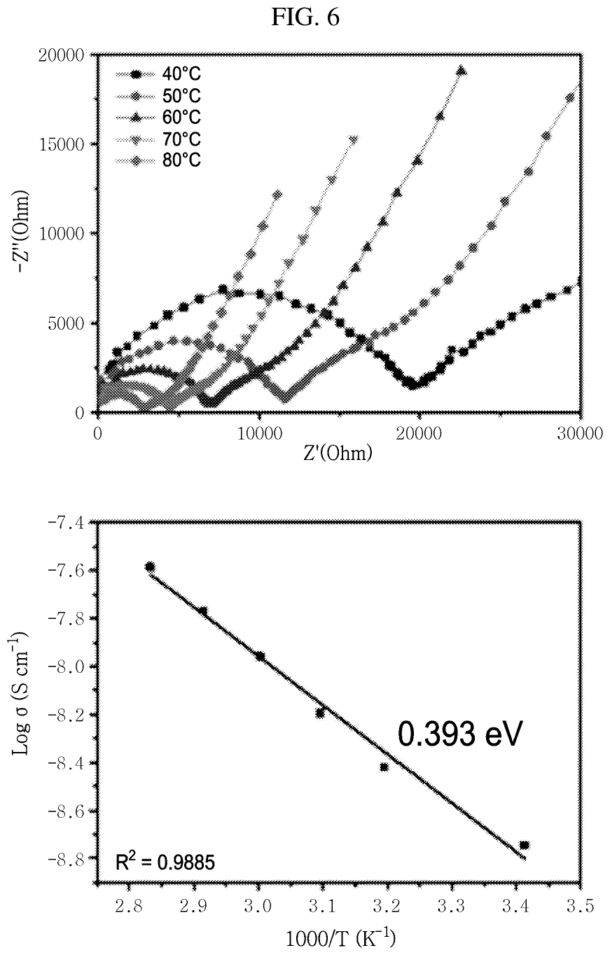

### MODE FOR CARRYING OUT THE INVENTION

Preferred embodiments of the present invention will be described below in more detail, and the description of the following embodiments is provided by way of example, but is not limited thereto.

### 1. Composition of Solid Electrolyte

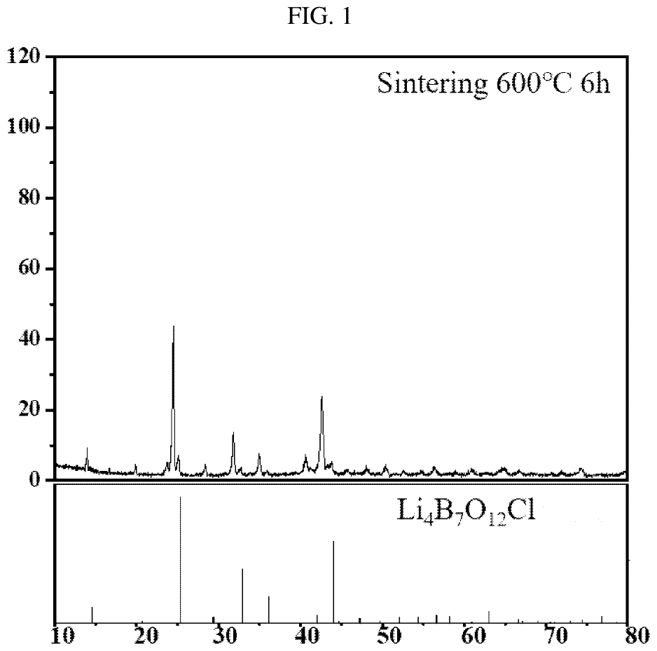

A solid electrolyte according to an embodiment of the present invention has a composition of lithium chloroboracite as shown below. (Refer to XRD data in FIG. 1)

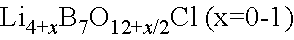

The lithium chloroborasite having the composition described above is prepared from LiOH or Li₂CO₃ and H₃BO₃ or B₂O₃ and LiCl raw materials, and has higher ionic conductivity and lower activation energy.

### 2. Measurement of Ion Conductivity According to Sample Conditions

The solid electrolyte according to an embodiment of the present invention had a Li ion conductivity of 1.0×10⁻⁶ S/cm or greater when measured at room temperature of 25° C. after sintering.

### —Electrical Conductivity Model/Measurement Conditions—

EIS SP-300, Scan fi=7.0 MHz, ff=1.0 Hz, Nd=10 points per decade
sinus amplitude Va=20.0 mV, pw=0.10, Na=2, E Range=−10 V-10 V

### 3. Manufacture of all Solid State Secondary Battery

A positive electrode layer, a negative electrode layer, and a solid electrolyte layer are prepared using a method below, and then stacked to manufacture an all solid state secondary battery.

The solid electrolyte may be a solid electrolyte having a composition according to an embodiment of the present invention. In an embodiment, the borate-based solid electrolyte is prepared by treating starting raw materials for the borate-based solid electrolyte using a method such as melt-quenching or mechanical milling. In addition, additional sintering may be performed after this treatment. The additional sintering promotes crystallization of the solid electrolyte, thereby exhibiting electrical conductivity.

The solid electrolyte according to an embodiment of the present invention is prepared by the following preparation method. First, LiOH or Li₂CO₃, H₃BO₃ or B₂O₃, and LiCl raw materials are mixed in a mixing ratio corresponding to lithium chloroborasite having a composition of Li₄₊ₓB₇O_{12+x/2}Cl (x=0-1).

A positive electrode layer, a negative electrode layer, and a solid electrolyte layer are stacked such that the solid electrolyte layer is sandwiched between the positive electrode layer and the negative electrode layer, and then rolled to manufacture an all solid state secondary battery according to an embodiment of the present invention.

### COMPARATIVE EXAMPLES AND EXAMPLES

TABLE 1

| | Comparative | Comparative | | | | | | |
|---|---|---|---|---|---|---|---|---|
| | Example 1 | Example 2 | Example 1 | Example 2 | Example 3 | Example 4 | Example 5 | Example 6 |
| Particle size (um) | Bulk | 50~100 | 20~50 | 1~20 | 50~100 | 1~20 | 50~100 | 1~20 |
| Sintering | 500 | 500 | 500 | 500 | 500 | 500 | 500 | 500 |
| temperature (° C.) | | | | | | | | |
| Sintering time (hr) | 6 | 6 | 6 | 6 | 3 | 3 | 6 | 6 |
| Conductivity (S cm − 1) | None | 5.5 × 10⁻⁶ | 8.9 × 10⁻⁸ | 3.3 × 10⁻⁷ | 4.5 × 10⁻⁹ | 2.2 × 10⁻⁷ | 5.3 × 10⁻⁷ | 1.0 × 10⁻⁶ |
| RT | | | | | | | | |
| 40° C. (S cm − 1) | None | 1.1 × 10⁻⁷ | 2.3 × 10⁻⁷ | 5.2 × 10⁻⁷ | 2.0 × 10⁻⁸ | 3.3 × 10⁻⁷ | 5.8 × 10⁻⁷ | 1.8 × 10⁻⁶ |
| 50° C. (S cm − 1) | None | 2.3 × 10⁻⁷ | 4.9 × 10⁻⁷ | 7.3 × 10⁻⁷ | 5.1 × 10⁻⁸ | 5.3 × 10⁻⁷ | 6.3 × 10⁻⁷ | 3.8 × 10⁻⁸ |
| 60° C. (S cm − 1) | None | 4.5 × 10⁻⁷ | 7.2 × 10⁻⁷ | 8.6 × 10⁻⁷ | 8.1 × 10⁻⁶ | 7.0 × 10⁻⁷ | 7.8 × 10⁻⁷ | 5.5 × 10⁻⁸ |
| 70° C. (S cm − 1) | None | 6.8 × 10⁻⁷ | 9.8 × 10⁻⁷ | 1.1 × 10⁻⁶ | 1.4 × 10⁻⁷ | 8.1 × 10⁻⁷ | 9.9 × 10⁻⁷ | 7.7 × 10⁻⁶ |
| 80° C. (S cm − 1) | None | 8.9 × 10⁻⁷ | 1.9 × 10⁻⁶ | 2.8 × 10⁻⁶ | 3.2 × 10⁻⁷ | 1.1 × 10⁻⁶ | 2.2 × 10⁻⁸ | 9.1 × 10⁻⁶ |

Comparative Example 1; Bulk lithium chloroboracite
Comparative Example 2; Ionic conductivity achieved by pulverization
Comparative Example 2 vs. Examples 1 and 2; Comparison by particle size
Comparative Example 2 vs. Example 3; Comparison by sintering time
Example 3 vs. Example 4; Comparison by size at modified sintering time
Comparative Example 2 vs. Example 5; Comparison by sintering temperature
Comparative Example 2 vs. Example 6; Comparison by size at modified sintering temperature

### Examples 1 to 6. Preparation of Solid Electrolyte

Lithium chloroboracite having the following composition was prepared by mixing LiOH or Li₂CO₃ and H₃BO₃ or B₂O₃ and LiCl raw materials. (Refer to XRD data in FIG. 1)

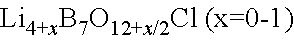

Comparative Examples 1 and 2; LiOH or Li₂CO₃ and H₃BO₃ or B₂O₃ and LiCl raw materials were mixed in the same manner as in Examples 1 to 6 to prepare a solid electrolyte of lithium chloroboracite having the following composition, which was then evaluated for ionic conductivity and stability.

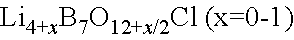

### <Evaluation of Ionic Conductivity of Solid Electrolyte>

The ionic conductivity of the solid electrolyte obtained in the present invention was measured using the following method (see Table 1).

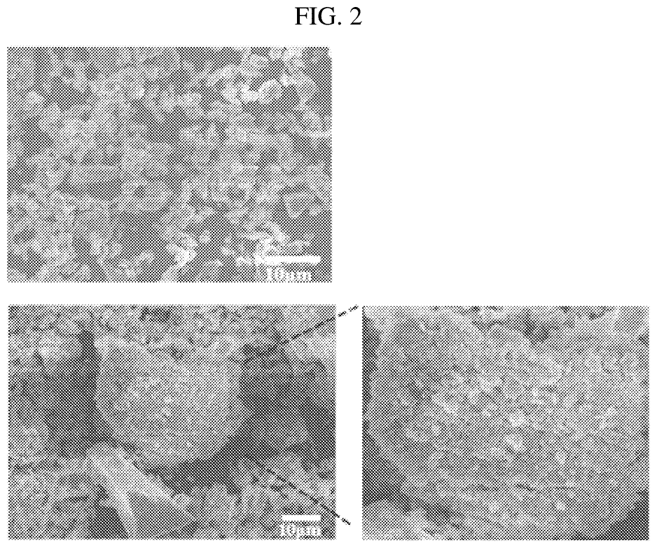

The solid electrolyte was pressed (at a pressure of 100 MPa/cm2) to produce pellets. Thereafter, as shown in FIG. 2, Au coating was performed to produce pellets for measuring ionic conductivity, and the Li ionic conductivity was measured at room temperature (25° C.) using an AC impedance measurement device. The ionic conductivity was found to be 1.8×10⁻⁶ S/cm or greater.

In addition, ionic conductivity was measured at varying temperatures: 40° C., 50° C., 60° C., 70° C., and 80° C.

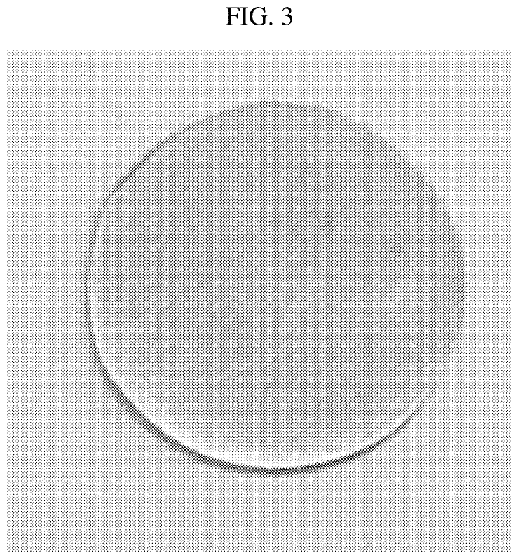

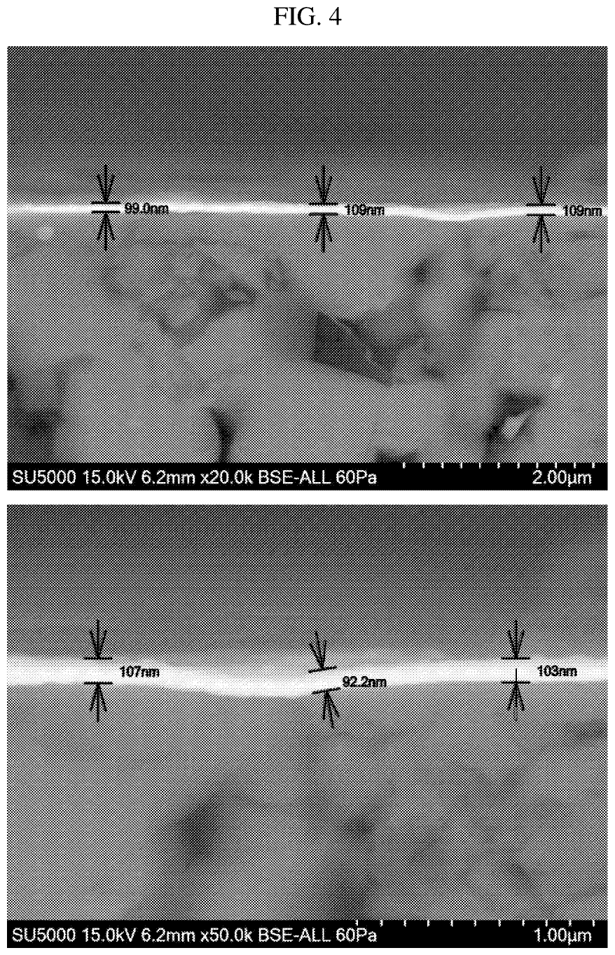

As shown in FIG. 4, the lithium chloroborasite coating thickness after the gold coating in FIG. 3, as determined by SEM-BSE (Back Scattered Electron), was 90 to 100 nm.

### <Stability of Solid Electrolyte>

The stability of typical lithium electrolytes is affected by reactions between cations and anions, requiring a separator or the like. However, the solid electrolyte according to the present invention is stable because cations and anions are separated by the solid electrolyte, preventing the two from meeting.

It is widely known that sulfides, as a typical all solid state electrolyte material, generate hydrogen sulfide according to the following Formula, and accordingly, are required to be manufactured in a moisture-free environment.

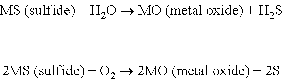

Conversely, the oxide-based lithium chloroboracite according to the present invention has very low reactivity with moisture in the air, and does not contain sulfur even if a reaction were to occur, resulting in no generation of hazardous substance hydrogen sulfide.

The solid electrolyte according to the present invention prepared as described above provides the following benefits.

1) The solid electrolyte offer superior safety, as they have no risk of evaporation from temperature changes or liquid leakage from external impacts, do not experience swelling, and are free from explosion or ignition even under extreme external conditions such as heat and pressure.

2) Stackable bipolar electrodes with a negative electrode and a positive electrode bonded to both sides of a current collector may be prepared. A high voltage of 10 V or greater may be achieved in a single cell with the application of bipolar electrodes. For example, to achieve 14.4 V in a lithium-ion battery, four 3.6 V cells are required, but this may be achieved with a single cell in an all solid state battery. The single cell design induces reduced volume from the decrease in components such as the separator, current collector, and cell external materials (pouches), and minimized BMS (battery management system), and thus allows for a high energy density per unit volume.

3) Unlike liquid electrolytes, a desolvation reaction, where lithium ions are separated from a solvent, is not required. The charge/discharge reaction directly translates into the diffusion reaction of lithium ions within the solid, enabling high output.

4) Compared to typical organic electrolytes, stable performance over a wider temperature range is obtainable. High ionic conductivity is expected, particularly at low temperatures. The biggest concern for electric vehicle users is the decline in battery performance in winter, resulting in reduced driving range. When a Tesla Model X is left parked overnight in the cold at a 50% charge, the charge level drops to 30% the next morning. The adoption of all solid state batteries will resolve the issue of instability in low-temperature environments.

5) The battery structure is simple and a separator is not required. During the manufacturing process, a slurry-like solid electrolyte is applied onto a positive electrode active material. Various types of multi-layer cells may be obtained through a continuous process without the need for a liquid electrolyte injection process.

1. A solid electrolyte of lithium chloroboracite having a composition of Li₄₊ₓB₇O_{12+x/2}Cl (x=0-1).

2. The solid electrolyte of claim 1, wherein the lithium chloroborasite is prepared from LiOH or Li₂CO₃ and H₃BO₃ or B₂O₃ and LiCl raw materials.

3. The solid electrolyte of claim 1, having a Li ionic conductivity of 1.0×10⁻⁶ S/cm or greater at room temperature (25° C.).

4. The solid electrolyte of claim 1, wherein the lithium chloroborasite is a nanoparticle having a diameter of 10 nm to 300 μm.

5. A secondary battery comprising the solid electrolyte according to claim 1.

6. A method for preparing a solid electrolyte of lithium chloroboracite having a composition of Li₄₊ₓB₇O_{12+x/2}Cl (x=0-1), the method comprising:
mixing LiOH or Li₂CO₃ and H₃BO₃ or B₂O₃ and LiCl raw materials;
melting and quenching the raw material mixture at 600° C. or greater; and
recovering, sintering, and pulverizing the melting after cooling.

7. A secondary battery comprising the solid electrolyte according to claim 2.

8. A secondary battery comprising the solid electrolyte according to claim 3.

9. A secondary battery comprising the solid electrolyte according to claim 4.
